(19) United States
(12) Patent Application Publication
(10) Pub. No.: US 2016/0288096 A1
(43) Pub. Date: Oct. 6, 2016

(54) EXHAUST GAS CONTROL CATALYST

(71) Applicants: TOYOTA JIDOSHA KABUSHIKI KAISHA, Toyota-shi, Aichi-ken (JP); CATALER CORPORATION, Kakegawa-shi, Shizuoka-ken (JP)

(72) Inventors: Takahiko FUJIWARA, Suntou-gun, Shizuoka-ken (JP); Yuki AOKI, Seto-shi, Aichi-ken (JP); Hiromasa SUZUKI, Toyota-shi, Aichi-ken (JP); Isao CHINZEI, Toyota-shi, Aichi-ken (JP); Yuji YABUZAKI, Susono-shi, Shizuoka-ken (JP)

(73) Assignees: TOYOTA JIDOSHA KABUSHIKI KAISHA, Toyota-shi, Aichi-ken (JP); CATALER CORPORATION, Kakegawa-shi, Shizuoka-ken (JP)

(21) Appl. No.: 15/035,413

(22) PCT Filed: Nov. 10, 2014
(86) PCT No.: PCT/IB2014/002384

§ 371 Date: May 9, 2016

(30) Foreign Application Priority Data
Nov. 14, 2013 (JP) 2013-235837

(51) Int. Cl. B01J 23/44; B01J 35/00; B01D 53/94; B01J 23/10

(52) U.S. Cl. CPC B01J 23/44; B01J 23/10; B01J 35/0006; B01D 53/945; B01D 2255/908; B01D 2255/9032; B01D 2255/407; B01D 2255/40; B01D 2255/1023

(57) ABSTRACT

Provided is an exhaust gas control catalyst in which a catalyst layer containing at least one of Pd and Pt is formed on a substrate (1), the exhaust gas control catalyst including a first OSC material having a pyrochlore structure and an OSC material whose oxygen storage rate is faster than that of the first OSC material having a pyrochlore structure in a catalyst layer front stage (21) which is in a range from an exhaust gas upstream end of the catalyst layer to a length position which is 50% or lower of a total length of the catalyst layer.

### BACKGROUND OF THE INVENTION

1. Field of the Invention

The present invention relates to an exhaust gas control catalyst for purifying exhaust gas which is emitted from an internal combustion engine.

2. Description of Related Art

Exhaust gas emitted from an internal combustion engine of an automobile or the like contains harmful components such as carbon oxide (CO), hydrocarbon (HC), and nitrogen oxide (NOₓ). These harmful components are emitted to the air after being purified by an exhaust gas control catalyst. In the related art, a three way catalyst with which oxidation of CO and HC and reduction of NOₓ are simultaneously performed is used for the exhaust gas control catalyst. As the three way catalyst, a catalyst in which a noble metal such as platinum (Pt), palladium (Pd), or rhodium (Rh) is supported on a porous oxide support such as alumina (Al₂O₃), silica (SiO₂), zirconia (ZrO₂), or titania (TiO₂) is widely used.

In order to efficiently purify the above-described harmful components in the exhaust gas using such a three way catalyst, an air-fuel ratio (A/F) which is a ratio of air to fuel in an air-fuel mixture supplied to an internal combustion engine is necessarily set in the vicinity of the theoretical air fuel ratio (stoichiometric ratio). However, depending on driving conditions and the like of an automobile, an actual air-fuel ratio becomes rich (fuel excess condition: A/F<14.7) or lean (oxygen excess condition: A/F>14.7) centering on the stoichiometric ratio, and the exhaust gas also becomes rich or lean correspondingly.

Recently, in order to enhance exhaust gas purification performance of a three way catalyst which varies depending on a change of oxygen concentration in exhaust gas, an OSC material which is an inorganic material having oxygen storage capacity (OSC) is used in a catalyst layer of an exhaust gas control catalyst. When the air-fuel mixture is lean and an oxygen concentration in exhaust gas is high (lean exhaust gas), the OSC material stores oxygen to promote a reduction of NOₓ in the exhaust gas. When the air-fuel mixture is rich and an oxygen concentration in exhaust gas is low, the OSC material releases oxygen to promote oxidation of CO and HC in the exhaust gas.

Japanese Patent Application Publication No. 2012-152702 (JP 2012-152702 A) discloses an exhaust gas control catalyst including: a substrate; a lower catalyst layer that is formed on the substrate and contains at least one of Pd and Pt; and an upper catalyst layer that is formed on the lower catalyst layer and contains Rh. In this exhaust gas control catalyst, a region that does not contain the upper catalyst layer is disposed on an exhaust gas upstream side of the exhaust gas control catalyst, the lower catalyst layer is formed of a front-stage lower catalyst layer disposed on the exhaust gas upstream side and a rear-stage lower catalyst layer disposed on an exhaust gas downstream side, and the front-stage lower catalyst layer contains an oxygen storage material. JP 2012-152702 A describes that, with this configuration, when a Ce₂Zr₂O₇ oxygen storage material having a pyrochlore phase whose oxygen storage rate is slower than that of the other crystal structures is used, catalytic metal particle growth can be inhibited.

Japanese Patent Application Publication No. 2013-130146 (JP 2013-130146 A) discloses an exhaust gas control apparatus including an exhaust gas control catalyst in which a catalyst layer which contains a support containing an OSC material having oxygen storage capacity and a noble metal catalyst supported on the support is formed on a substrate. In this exhaust gas control catalyst, the support in a predetermined region from a catalyst-outlet-side end at the downstream side of the exhaust gas control catalyst contains an OSC material having a pyrochlore structure and an OSC material whose oxygen storage rate is faster than that of the OSC material having a pyrochlore structure.

In JP 2013-130146 A, the OSC material having a pyrochlore structure and the OSC material whose oxygen storage rate is faster than that of the OSC material having a pyrochlore structure are used together in an exhaust gas downstream portion of the catalyst layer. However, since an oxygen storage and release reaction actively occurs in an exhaust gas upstream portion of the catalyst layer, oxygen in the exhaust gas is consumed in the exhaust gas upstream portion of the catalyst layer and hardly reaches the exhaust gas downstream portion of the catalyst layer. Therefore, a catalytic reaction inactively occurs in the exhaust gas downstream portion of the catalyst layer. In addition, when the above-described two OSC materials are used together, and when the amount of the OSC material whose oxygen storage rate is faster than that of the OSC material having a pyrochlore structure is more than that of the OSC material having a pyrochlore structure, the OSC material having, a pyrochlore structure cannot efficiently utilize oxygen, and thus an effect thereof decreases.

In addition, in order to inhibit catalyst deterioration, to reduce a decrease, called sulfur poisoning, in the purification performance of a catalyst, and to reduce NOₓ emission, a catalyst which can maintain an activity when the air-fuel mixture is rich is desired, the sulfur poisoning being caused by a sulfur component in exhaust gas being coated on a surface of a noble metal (for example, Pd) contained in an exhaust gas control catalyst, and the NOₓ emission being caused by fluctuation in air-fuel ratio.

As described above, for the exhaust gas downstream portion of the catalyst layer, an exhaust gas control catalyst which causes a catalytic reaction to actively occur is also required. In particular, when an air-fuel mixture supplied to an engine is rich, it is required to provide an exhaust gas control catalyst having higher NOₓ reduction performance than in the past.

### SUMMARY OF THE INVENTION

The present invention provides an exhaust gas control catalyst which causes a catalytic reaction to actively occur even in an exhaust gas downstream portion of a catalyst layer and has improved NOₓ reduction performance.

The present inventors have found that the NOₓ reduction performance of an exhaust gas control catalyst is improved by a catalyst layer of the exhaust gas control catalyst containing, in a predetermined range of an exhaust gas upstream portion, a first OSC material having a pyrochlore structure and a second OSC material whose oxygen storage rate is faster than that of the first OSC material, thereby completing the invention.

An aspect of the invention relates to an exhaust gas control catalyst in which a catalyst layer containing at least one of Pd and Pt is formed on a substrate. This exhaust gas control catalyst includes a first OSC material having a pyrochlore structure and a second OSC material whose oxygen, storage rate is faster than that of the first OSC material. The first OSC material and the second OSC material are provided in a catalyst layer front stage which is in a range from an exhaust gas upstream end of the catalyst layer to a length position which is 50% or lower of a total length of the catalyst layer.

In the exhaust gas control catalyst, a total content of the first OSC material and the second OSC material in the catalyst layer front stage may be 80 g or less per 1 L of the substrate.

In the exhaust gas control catalyst, a content of the first OSC material in the catalyst layer front stage may be 2 wt % to 10 wt % with respect to the total content of the first OSC material and the second OSC material.

The exhaust gas control catalyst may further include a noble metal catalyst layer that is formed on the catalyst layer.

According to the present invention, there is provided an exhaust gas control catalyst having improved NOₓ reduction performance.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an enlarged cross-sectional view of an exhaust gas control catalyst illustrating an embodiment of an exhaust gas control catalyst according to the present invention;

FIG. 2 is an enlarged cross-sectional view of an exhaust gas control catalyst illustrating another embodiment of the exhaust gas control catalyst according to the present invention;

FIG. 3 is an enlarged cross-sectional view of an exhaust gas control catalyst illustrating an embodiment of an exhaust gas control catalyst according to Example 1;

FIG. 4 is a graph illustrating NOₓ reduction performance of exhaust gas control catalysts of Example 1 and a comparative example; and

FIG. 5 is a graph illustrating an influence of a content of two OSC materials and a content of an OSC material having a pyrochlore structure in a lower catalyst layer front stage of an exhaust gas control catalyst on NOₓ reduction performance.

### DETAILED DESCRIPTION OF EMBODIMENTS

Hereinafter, preferred embodiments of the invention will be described in detail.

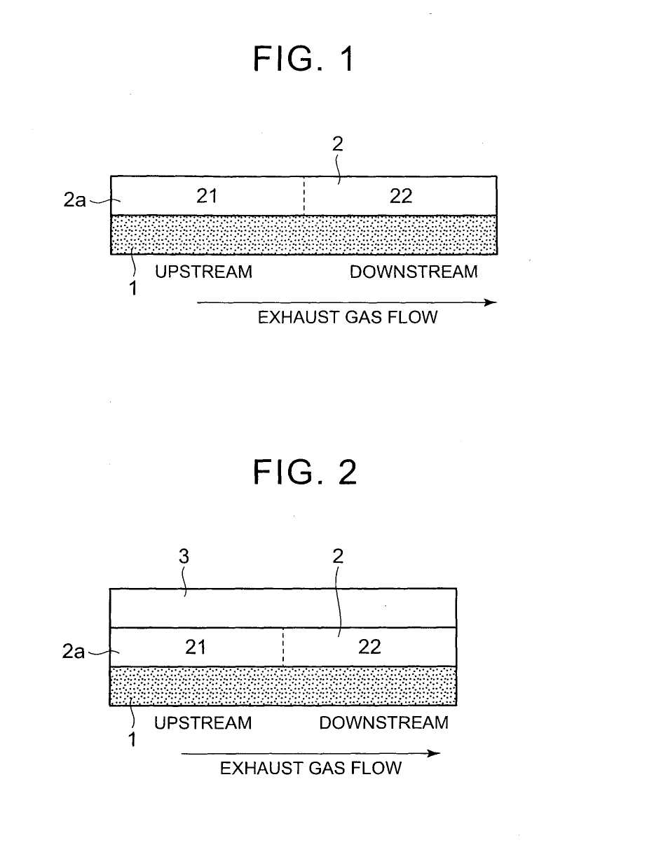

An embodiment of the invention relates to an exhaust gas control catalyst. FIG. 1 is an enlarged cross-sectional view of an exhaust gas control catalyst illustrating an embodiment of the exhaust gas control catalyst according to the present invention. The exhaust gas control catalyst according to the invention includes a substrate 1 and a catalyst layer 2 that is formed by coating on the substrate 1.

The substrate of the exhaust gas control catalyst is not particularly limited, and an arbitrary material which is commonly used in an exhaust gas control catalyst can be used. Specifically, as the substrate, a honeycomb-shaped material having plural cells can be used, and examples thereof include ceramic materials having heat resistance such as cordierite (2MgO.2Al₂O₃.5SiO₂), alumina, zirconia, and silicon carbide; and metallic materials formed of a metallic foil such as stainless steel.

The catalyst layer of the exhaust gas control catalyst is formed on the substrate. Exhaust gas supplied to the exhaust gas control catalyst comes into contact with the catalyst layer while flowing through a flow channel of the substrate. As a result, harmful contents are purified. For example, CO and HC contained in the exhaust gas are oxidized into water (H₂O), carbon dioxide (CO₂), and the like by a catalytic function of the catalyst layer, and NOₓ is reduced into nitrogen (N₂) by a catalytic function of the catalyst layer.

The total length of the catalyst layer is not particularly limited but is, for example, 2 cm to 30 cm, preferably 5 cm to 15 cm, and more preferably about 10 cm from the viewpoint of appropriate decrease of the harmful components in the exhaust gas, the production cost, and the degree of freedom on equipment design.

The catalyst layer of the exhaust gas control catalyst includes at least one catalytic metal of Pd and Pt and includes an OSC material having a pyrochlore structure and an OSC material whose oxygen storage rate is faster than that of the OSC material having a pyrochlore structure in a range (catalyst layer front stage) from an exhaust gas upstream end of the catalyst layer to a length position which is 50% or lower of a total length of the catalyst layer. By exhaust gas control catalyst containing these two OSC materials having different crystal structures, oxygen even reaches an exhaust gas downstream portion of the catalyst layer, and a catalytic reaction actively occurs. Therefore, the amount of NOₓ emission can be inhibited.

The range of the catalyst layer where the two OSC materials having different crystal structures are contained from the exhaust gas upstream end of the catalyst layer to a length position which is preferably 50% or lower of the total length of, the catalyst layer. However, for example, the length position may be 40% or lower or 30% or lower of the total length of the catalyst layer.

In FIG. 1 illustrating an embodiment of the exhaust gas control catalyst according to the invention, at least one catalytic metal of Pd and Pt, an OSC material having a pyrochlore structure, and an OSC material whose oxygen storage rate is faster than that of the OSC material having a pyrochlore structure are contained in a range (catalyst layer front stage 21) from an exhaust gas upstream end 2a of a catalyst layer 2 to a length position which is 50% or lower of a total length of the catalyst layer 2. In addition, as described below, an exhaust gas downstream portion (catalyst layer rear stage 22) of the catalyst layer 2 other than the catalyst layer front stage 21, contains at least one catalytic metal of Pd and Pt and may further contain the OSC material whose oxygen storage rate is faster than that of the OSC material having a pyrochlore structure.

The catalyst layer contains at least one of Pd and Pt as the catalytic metal. The catalytic metal contained in the catalyst layer is not limited to only Pd and/or Pt. Optionally, the catalyst layer may appropriately contain other metals such as Rh, in addition to the above metals or instead of a part of the above metals.

In the embodiment of the invention, the OSC material can be used as a support on which the catalytic metal is supported. The OSC material is an inorganic material having oxygen storage capacity, and stores oxygen when lean exhaust gas is supplied thereto and releases the stored oxygen when rich exhaust gas is supplied thereto. Examples of the OSC material include cerium oxide (ceria: CeO₂) and composite oxides (for example, ceria-zirconia composite oxide (CZ composite oxide)) containing ceria. Among these OSC materials, CZ composite oxide is preferably used due to its high oxygen storage capacity and relatively low price. A mixing ratio (CeO₂/ZrO₂) of ceria to zirconia in the CZ composite oxide is preferably 0.65 to 1.5 and more preferably 0.75 to 1.3.

In the embodiment of the invention, in the catalyst layer front stage, as the OSC material, an OSC material having a pyrochlore structure and an OSC material whose oxygen storage rate is faster than that of the OSC material having a pyrochlore structure are used together. Since these two OSC materials having different oxygen storage rates are used together, oxygen can be stored in these OSC materials at an appropriate speed. Therefore, oxygen reaches even the exhaust gas downstream portion of the catalyst layer, and a catalytic reaction actively occurs.

Regarding the OSC material having a pyrochlore structure, the pyrochlore structure contains two metal elements A and B, is represented by A₂B₂O₇ where B is a transition metal element, a type of crystal structure formed of a combination A³⁺/B⁴⁺or A²⁺/B⁵⁺, and is produced when the ion radius of A in the crystal structure having such a configuration is relatively small. When the CZ composite oxide is used as the OSC material, the chemical formula of the OSC material having a pyrochlore structure is represented by Ce₂Zr₂O₇, in which Ce and Zr are alternately regularly arranged with oxygen interposed therebetween. The OSC material having a pyrochlore structure has a slower oxygen storage rate than an OSC material having another crystal structure (for example, a fluorite structure) and can release oxygen even after the OSC material having another crystal structure has ceased to release oxygen. That is, the OSC material having a pyrochlore structure can exhibit oxygen storage capacity even after the peak of the oxygen storage by the OSC material having another structure has been passed. The reason is considered to be that, in the OSC material having a pyrochlore structure, the crystal structure is complex and thus the pathways during oxygen storage are also complex. More specifically, in the OSC material having a pyrochlore structure, the total amount of oxygen released during a period from 10 seconds to 120 seconds after the start of oxygen release is, for example, 60% to 95%, preferably 70% to 90%, and more preferably 75% to 85% with respect to 100% of the total amount of oxygen released during a period from the very beginning (0 seconds) to 120 seconds after the start of oxygen release.

Specific examples of a crystal structure of the OSC material whose oxygen storage rate is faster than that of the OSC material having a pyrochlore structure include a fluorite structure. The OSC material having a fluorite structure has a faster oxygen storage rate than the OSC material having a pyrochlore structure. Therefore, even if exhaust gas is supplied at a high flow rate, an amount of harmful components can be suitably reduced.

It is more preferable that the two OSC materials which are present together in the catalyst layer front stage be formed of the same composite oxide and be different from each other in their crystal structures. In this case, since the two OSC materials can be suitably dispersed in the support in the predetermined range, the oxygen storage rate of the OSC material whose oxygen storage rate is faster than that of the other one can be further improved. Specifically, it is preferable that the two OSC materials which are present together in the above-described region be ceria-zirconia composite oxide.

In the embodiment of the invention, the catalyst layer front stage may further contain a support other than the OSC materials in addition to the two OSC materials and the catalytic metal. As the support material other than the OSC materials, a porous metal oxide having superior heat resistance can be used, and examples thereof include aluminum oxide (alumina: Al₂O₃), zirconium oxide (zirconia (ZrO₂), silicon oxide (silica: SiO₂), and composite oxides containing the above metal oxides as a major component.

In addition, the catalyst layer front stage may contain other materials (typically, an inorganic oxide) as an accessory component. Examples of a material which can be added to the catalyst layer front stage include rare earth elements such as lanthanum (La) and yttrium (Y); alkali earth elements such as calcium; and other transition metal elements. Among these, rare earth elements such as lanthanum and yttrium are preferably used as a stabilizer because they can improve a specific surface area at a high temperature without inhibiting a catalytic function. In addition, a content ratio of the accessory component of the OSC materials is preferably 10 wt % or less and more preferably 5 wt % or less.

The total content of the two OSC materials (the OSC material having a pyrochlore structure and the OSC material whose oxygen storage rate is faster than that of the OSC material having a pyrochlore structure) in the catalyst layer front stage is 80 g or less per 1 L of the substrate. When the total content of the two OSC materials in the catalyst layer front stage is 80 g or less per 1 L of the substrate, the amount of NOₓ emission can be reduced as compared to a case where the total content is greater than 80 g/1 L substrate.

The content of the OSC material having a. pyrochlore structure in the catalyst layer front stage is preferably 2 wt % to 12 wt %, more preferably 2 wt % to 10 wt %, and still more preferably 6 wt % to 9 wt % with respect to the total content of the two OSC materials (the OSC material having a pyrochlore structure and the OSC material whose oxygen storage rate is faster than that of the OSC material having a pyrochlore structure) in the range. When the content of the OSC material having a pyrochlore structure in the catalyst layer front stage is in this range with respect to the total content of the two OSC materials, the amount of NOₓ emission can be reduced.

A content ratio of the two OSC materials which are present together in the catalyst layer front stage can he investigated by measuring a peak intensity by X-ray diffraction analysis. Specifically, when the X-ray diffraction analysis is performed on constitutional materials in the predetermined range, characteristic peaks appear in the vicinity of 2θ/θ=14° and in the vicinity of 2θ/θ=29°. Among these peaks, a peak in the vicinity of 2θ/θ=14° is derived from the pyrochlore structure, and a peak in the vicinity of 2θ/θ=29° is derived from another crystal structure (for example, a fluorite structure). Accordingly, by changing a ratio of a composite oxide having a pyrochlore structure to a composite oxide having another crystal structure, that is, by adjusting a value ¹_{14/29} which is obtained by dividing a peak intensity in the vicinity of 2θ/θ=14° by a peak intensity in the vicinity of 2θ/θ=29°, an exhaust gas control catalyst in which the two OSC materials are present together in the catalyst layer front stage at an appropriate ratio can be obtained.

In the catalyst layer of the exhaust gas control catalyst according to the embodiment of the invention, an exhaust gas downstream portion (catalyst layer rear stage) other than the catalyst layer front stage contains at least one of Pd and Pt and may further contain the OSC material whose oxygen storage rate is faster than that of the OSC material having a pyrochlore structure. As in the case of the catalyst layer front stage, the catalyst layer rear stage may contain a support other than the OSC materials and other materials as an accessory component. According to a preferred embodiment of the invention, the catalyst layer rear stage contains at least one of Pd and Pt and the OSC material whose oxygen storage rate is faster than that of the OSC material having a pyrochlore structure.

The catalyst layer front stage and the catalyst layer rear stage can be formed by coating on the substrate using a method well-known to a person skilled in the art. For example, at least one of Pd and Pt, the two OSC materials, and optionally other components of the catalyst layer are coated on a predetermined range of an exhaust gas upstream portion of the substrate using a well-known wash coating method, followed by drying and firing at a predetermined temperature for a predetermined time. As a result, the catalyst layer front stage is formed on the substrate. Next, using the same method as above, the catalyst layer rear stage containing at least one of Pd and Pt and other components of the catalyst layer rear stage such as the OSC material whose oxygen storage rate is faster than that of the OSC material having a pyrochlore structure can be formed on an exhaust gas downstream side of the obtained catalyst layer front stage. When each catalyst layer of the exhaust gas control catalyst is formed using a wash coating method, for example, a method may be adopted in which, after a layer of the OSC materials and/or another support is formed using a wash coating method, at least one of Pd and Pt is supported on the obtained layer using a well-known impregnation method or the like of the related art. Alternatively, wash coating may be performed using powder of the OSC materials and/or another support on which the catalytic metal is supported in advance using an impregnation method or the like.

The exhaust gas control catalyst may further contain a noble metal catalyst layer (also referred to as “upper catalyst layer”) that is formed by coating on the catalyst layer (also referred to as “lower catalyst layer”). By further containing the noble metal catalyst layer, the exhaust gas purification performance of the exhaust gas control catalyst can be improved.

The noble metal catalyst layer may contain a catalytic metal and a support on which the catalytic metal is supported. As a noble metal catalyst, a catalytic metal for an exhaust gas control catalyst which is well-known in the related art can be used. Specifically, the noble metal catalyst is not particularly limited as long as it has a catalytic function to harmful contents contained in exhaust gas, and noble metal particles formed of various noble metal elements can be used. As the metal which can be used in the noble metal catalyst, for example, any metal belonging to the platinum group or an alloy containing a metal belonging to the platinum group as a major component can be preferably used. Examples of the metal belonging to the platinum group include platinum (Pt), palladium (Pd), rhodium (Rh), ruthenium (Ru), iridium (Ir), and osmium (Os). The support on which the catalytic metal is supported is not particularly limited, and examples thereof include aluminum oxide (alumina: Al₂O₃), zirconium oxide (zirconia (ZrO₂), silicon oxide (silica: SiO₂), and composite oxides containing the above oxides as a major component.

The noble metal catalyst layer may contain other materials (typically, an inorganic oxide) as an accessory component. Examples of a material which can be added to the noble metal catalyst layer include rare earth elements such as lanthanum (La) and yttrium (Y); alkali earth elements such as calcium; and other transition metal elements. Among these, rare earth elements such as lanthanum and yttrium are preferably used as a stabilizer because they can improve a specific surface area at a high temperature without inhibiting a catalytic function.

The noble metal catalyst layer can be formed, as in the case of the catalyst layer, by coating a layer containing the catalytic metal and the support using a wash coating method or the like on a predetermined range on the catalyst layer formed on the substrate, followed by drying and firing at a predetermined temperature for a predetermined time.

FIG. 2 illustrates a preferred embodiment of the exhaust gas control catalyst according to the invention. The exhaust gas control catalyst contains an upper catalyst layer 3 (noble metal catalyst layer) that is formed by coating on the lower catalyst layer front stage 21 and the lower catalyst layer rear stage 22. In the preferred embodiment of the invention, the lower catalyst layer front stage 21 is provided in a range from the exhaust gas upstream end 2a of the catalyst layer 2 to a length position which is 50% or lower of a total length of the catalyst layer 2 and contains at least one catalytic metal of Pd and Pt, the OSC material having a pyrochlore structure, and the OSC material whose oxygen storage rate is faster than that of the OSC material having a pyrochlore structure. The lower catalyst layer rear stage 22 contains at least one catalytic metal of Pd and Pt and the OSC material whose oxygen storage rate is faster than that of the OSC material having a pyrochlore structure. The upper catalyst layer 3 contains any catalytic metal belonging to the platinum group.

Hereinafter, the invention will be described in more detail using Examples. However, the technical scope of the invention is not limited to these Examples.

### EXAMPLE 1

### Exhaust Gas Control Catalyst

As the OSC materials, CeO₂—ZrO₂ composite oxide was used.

[Preparation of OSC Material having Pyrochlore Structure]

49.1 g of an aqueous cerium nitride solution having a concentration of 28 wt % in terms of CeO₂, 54.7 g of an aqueous zirconium oxynitrate solution having a concentration of 18 wt % in terms of ZrO₂, and a commercially available surfactant were dissolved in 90 mL of ion exchange water. An ammonia solution containing 25 wt % of NH₃ was added in an amount of 1.2 equivalents with respect to anions to produce a coprecipitate, and the obtained coprecipitate was filtered and washed. Next, the obtained coprecipitate was dried at 110° C. and was fired in the air at 500° C. for 5 hours to obtain a solid solution of cerium and zirconium. Next, the obtained solid solution was crushed into an average particle size of 1000 nm using a crusher to obtain a CeO₂—ZrO₂ solid solution powder in which a content molar ratio (CeO₂/ZrO₂) of CeO₂ to ZrO₂ was 1.09. Next, a polyethylene bag was filled with this CeO₂—ZrO₂ solid solution powder, the inside thereof was degassed, and the bag was then sealed by heating. Next, using an isostatic pressing machine, the CeO₂—ZrO₂ solid solution powder was press-molded under a pressure of 300 MPa for 1 minute to obtain a solid raw material of the CeO₂—ZrO₂ solid solution powder. Next, the obtained solid raw material was put into a graphite crucible, and the graphite crucible was covered with a graphite lid, followed by reduction in Ar gas at 1700° C. for 5 hours. The reduced material was crushed using a crusher to obtain powder of CeO₂—ZrO₂ composite oxide having a pyrochlore structure with an average particle size of about 5 μm.

[Formation of Lower Catalyst Layer Front Stage]

Palladium was supported by impregnation using a palladium nitrate solution such that a ratio of metal palladium to 40 g/1 L substrate of lanthanum-added alumina (La₂O₃/Al₂O₃=4/96 wt %) was 1 g/1 L substrate. The substrate was dried at 120° C. for 30 minutes and then fired at 500° C. for 2 hours to obtain a Pd-supported powder. The obtained Pd-supported powder (41 g/1 L substrate), the obtained OSC material having a pyrochlore structure (4.8 g/1 L substrate), the OSC material whose oxygen storage rate is faster than that of the OSC material having a pyrochlore structure (35.2 g/1 L substrate), water, and a binder (5 g/1 L substrate) were mixed, and the pH and viscosity thereof were adjusted using acetic acid or the like to obtain a slurry for the lower catalyst layer front stage.

Next, the obtained slurry was coated using a wash coating method on an exhaust gas upstream portion of a ceramic honeycomb substrate (φ 103 mm, L 105 mm, volume 875 cc, cordierite), in which plural cells were partitioned by a partition wall, at a width which was 50% of the total length of the honeycomb substrate, followed by drying and firing. As a result, a lower catalyst layer front stage was formed on a cell surface of the honeycomb substrate.

[Formation of Lower Catalyst Layer Rear Stage]

A slurry was prepared in the same procedure as the lower catalyst layer front stage, except that the OSC material having a pyrochlore structure was not used. Next, the obtained slurry was coated using a wash coating method on an exhaust gas downstream portion of the honeycomb substrate, on which the lower catalyst layer front stage was formed, at a width which was 50% of the total length of the honeycomb substrate, followed by drying and firing. As a result, a lower catalyst layer rear stage was formed on the cell surface of the honeycomb substrate.

[Formation of Upper Catalyst Layer]

Next, using an rhodium nitrate solution, Rh (0.2 g/1 L substrate) was supported by impregnation on 40 g/1 L substrate of the OSC material whose oxygen storage rate is faster than that of the OSC material having a pyrochlore structure. The substrate was dried at 120° C. for 30 minutes and then fired at 500° C. for 2 hours to obtain a Rh-supported powder. Next, this Rh-supported powder (40.2 g/1 L substrate), lanthanum-added alumina used in the lower catalyst layer front stage (40 g/1 L substrate), water, and a binder (5 g/1 L substrate) were mixed, and the pH and viscosity thereof were adjusted using acetic acid or the like to obtain a slurry for the upper catalyst layer front stage. Next, the obtained slurry was coated using a wash coating method on the entire portion of the honeycomb structure on which the lower catalyst layer front stage and the lower catalyst layer rear stage were formed, followed by drying and firing. As a result, an exhaust gas control catalyst in which the upper catalyst layer was formed on the lower catalyst layer including the lower catalyst layer front stage and the lower catalyst layer rear stage was obtained.

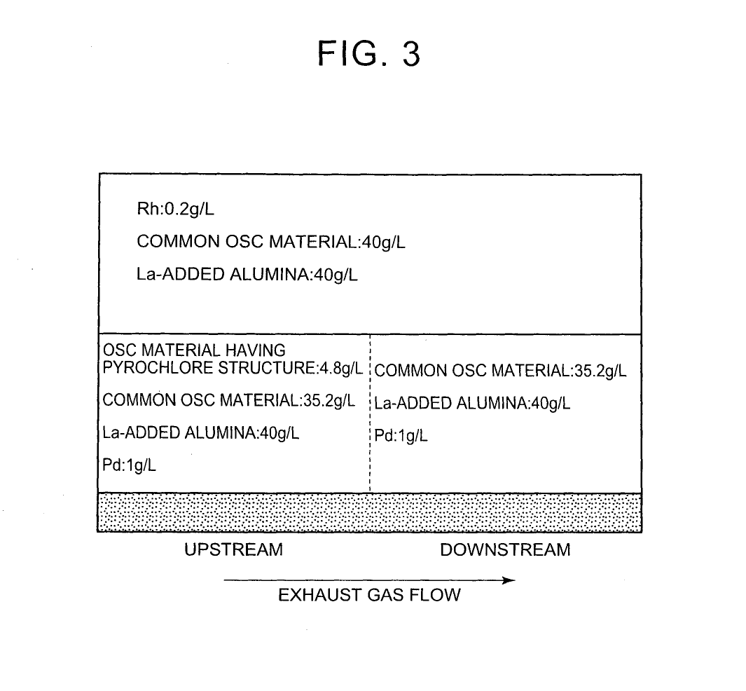

FIG. 3 illustrates the exhaust gas control catalyst obtained in Example 1. In FIG. 3, the common OSC material represents the OSC material whose oxygen storage rate is faster than that of the OSC material having a pyrochlore structure.

A catalyst of a comparative example was prepared with the same method as in Example 1, except that the OSC material having a pyrochlore structure was removed from the lower catalyst layer front stage of Example 1.

### EXAMPLE 2

### Evaluation of NOₓ Reduction Performance of Exhaust Gas Control Catalyst

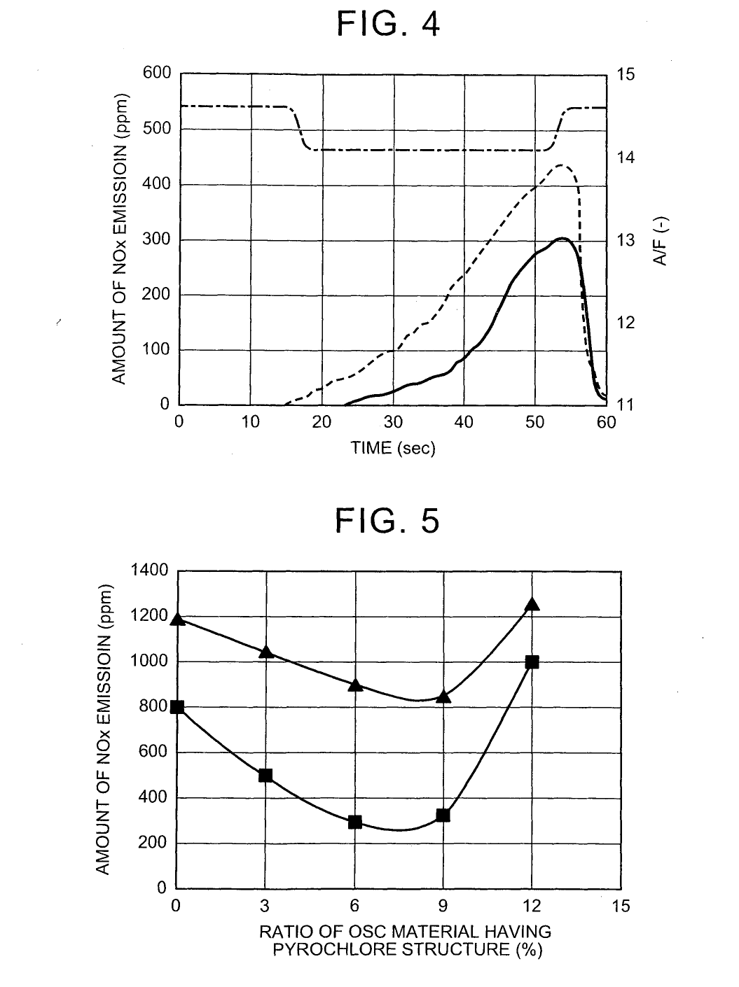

Regarding the exhaust gas control catalyst of Example 1 and the exhaust gas control catalyst of the comparative example, an exhaust test corresponding to 150,000 miles was performed. Next, each of the exhaust gas control catalysts was mounted on a L4 engine having a displacement of 2.5 L, and exhaust gas was supplied to the engine for 15 seconds at an intake air flow rate (Ga) of 20 g/sec. In this case, the temperature of exhaust gas flowing into the catalyst was 600° C., and an air-fuel ratio (A/F) flowing into the catalyst was 14.6. Next, exhaust gas having an air-fuel ratio of 14.1 was supplied to the engine for 30 seconds, and the amount of NOₓ emissions was measured at a catalyst outlet side to evaluate the NOₓ reduction performance of each of the exhaust gas control catalysts. The results are shown in FIG. 4. In FIG. 4, a solid line represents the amount of NOₓ emission of the exhaust gas control catalyst of Example 1, a dotted line represents the amount of NOₓ emission of the exhaust gas control catalyst of the comparative example, and a chain line represents an air-fuel ratio (A/F).

As clearly seen from FIG. 4, the exhaust gas control catalyst of Example 1 exhibited extremely higher NOₓ reduction performance than the exhaust gas control catalyst of the comparative example under the condition that the air-fuel ratio of the exhaust gas was rich.

### Example 3

### Influence of Total Content of OSC Materials and Content of OSC Material Having Pyrochlore Structure on NOₓ Reduction Performance

Regarding the exhaust gas control catalysts, the amount of NOₓ emission was measured while changing the total amount of the two OSC materials (the OSC material having a pyrochlore structure and the OSC material whose oxygen storage rate is faster than that of the OSC material having a pyrochlore structure) in the lower catalyst layer front stage, and the amount of NOₓ emission was measured while changing the content of the OSC material having a pyrochlore structure in the lower catalyst layer front stage with respect to the total content of the two OSC materials.

As the exhaust gas control catalysts, Catalysts 1 to 10 shown in Table 1 below and the catalyst of Example 1 were prepared using the same method as above, in which the total content of the two OSC materials in the lower catalyst layer front stage was 80 g/1 L substrate or 100 g/1 L substrate, and the content of the OSC material having a pyrochlore structure were 0, 3, 6, 9, or 12 wt % with respect to the total content of the two OSC materials in each of the catalysts. In Table 1, all the OSC materials represent the two OSC materials contained in a range (lower catalyst layer front stage) from the exhaust gas upstream end of the lower catalyst layer to a length position which is 50% or lower of the total length of the lower catalyst layer.

TABLE 1

| | Ratio of OSC Material | Content of All OSC |
|---|---|---|
| | Having Pyrochlore | Materials |
| | Structure/All OSC Materials | (g/L) |
| Catalyst 1 | 0 | 80 |
| Catalyst 2 | 3 | |
| Catalyst 3 | 6 | |
| Catalyst 4 | 9 | |
| Catalyst 5 | 12 | |
| Catalyst 6 | 0 | 100 |
| Catalyst 7 | 3 | |
| Catalyst 8 | 6 | |
| Catalyst 9 | 9 | |
| Catalyst 10 | 12 | |

Regarding Catalysts 1 to 10, the same test as the NOₓ reduction performance test of Example 2 was performed, and the amount of NOₓ emission was measured 30 seconds after the air-fuel ratio was changed to 14.1. The results are shown in FIG. 5. In FIG. 5, the black square represents the amount of NOₓ emission measured when the total content of the two OSC materials in the lower catalyst layer front stage was 80 g/1 L substrate (Catalysts 1 to 5), and the black triangle represents the amount of NOₓ emission measured when the total content of the two OSC materials in the lower catalyst layer front stage was 100 g/1 L substrate (Catalysts 6 to 10)

In FIG. 5, when the total content of the two OSC materials in the lower catalyst layer front stage was 80 g/1 L substrate, the amount of NOₓ emission was reduced as compared to a case where the total content was 100 g/1 L substrate. In addition, when the content of the OSC material having a pyrochlore structure in the lower catalyst layer front stage was 2 wt % to 10 wt % with respect to the total content of the two OSC materials, the amount of NOₓ emission was reduced. When the content of the OSC material having a pyrochlore structure is in this range, the OSC material having a pyrochlore structure can efficiently utilize oxygen. For this reason, it is considered that a catalytic reaction actively occurred and the exhaust gas control performance of the catalyst was improved.

By using the exhaust gas control catalyst according to the present invention, an exhaust gas control catalyst having improved NOₓ reduction performance can be provided.

1. An exhaust gas control catalyst in which a catalyst layer containing at least one of Pd and Pt is formed on a substrate, comprising:
a catalyst layer front stage which is provided in a range from an exhaust gas upstream end of the catalyst layer to a length position which is 50% or lower of a total length of the catalyst layer and contains a first OSC material having a pyrochlore structure and a second OSC material whose oxygen storage rate is faster than an oxygen storage rate of the first OSC material; and
a catalyst layer rear stage which is provided a portion downstream of a follow direction of an exhaust gas other than the catalyst layer front stage and contains the second OSC material and at least one of Pd and Pt.

2. The exhaust gas control catalyst according to claim 1, wherein
a total content of the first OSC material and the second OSC material in the catalyst layer front stage is 80 g or less per 1 L of the substrate.

3. The exhaust gas control catalyst according to claim 1, wherein
a content of the first OSC material in the catalyst layer front stage is 2 wt % to 10 wt % with respect to the total content of the first OSC material and the second OSC material.

4. The exhaust gas control catalyst according to claim 1, further comprising:
a noble metal catalyst layer that is formed on the catalyst layer.
